(19) United States
(12) Patent Application Publication
(10) Pub. No.: US 2007/0156484 A1
(43) Pub. Date: Jul. 5, 2007

(54) Cross company project management

(76) Inventors: Sandra Fischbach, Bruchsal (DE); Volker Faisst, Ilvesheim (DE)

Correspondence Address: KENYON & KENYON LLP, 1500 K STREET N.W., WASHINGTON, DC, 20005, US

(21) Appl. No.: 11/319,440

(22) Filed: Dec. 29, 2005

(51) Int. Cl. G05B 19/418

(52) U.S. Cl. 705/8

(57) ABSTRACT

Cross company project management includes receiving guideline data for a project, where the project includes one or more phases, each phase including one or more tasks and each task including one or more sub-projects. The project management further includes determining associated data utilized for each of the sub-projects and a determination of which of the sub-projects are to be completed by a third party. Based on the guideline data, when timely in the project, the associated data is provided to the third party through a data exchange device. Various operations in the sub-project may be completed by the third party and the third party thereupon generates updated project data. The updated project data is provided to a central repository and project status feedback data is thereupon provided to a project manager based on te updated project data and the guideline data.

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyright rights whatsoever.

### BACKGROUND OF THE INVENTION

The present invention relates generally to project management and more specifically to electronically monitoring the status of multi-party projects and providing relationship feedback during different phases of the projects.

In many industries there are extremely complex projects that include many different sub-layers. Complex projects can include different phases, each phase having numerous tasks and each task having any number of sub-tasks. In many of these complex projects, an essential component is not only the completion of sub-tasks, but also the corresponding collection and management of data from these sub-tasks.

Management and data collection in existing systems is usually completed using a general database application where all sub-projects for the tasks are internally completed. Using known database data collection techniques, internally accessible databases can receive the collected data directly from the party collecting the data. The existing systems may include a general interface for data entry that is collected for each sub-project. This data is then collectively categorized and stored in the database.

As the complexity of these tasks increase, it is becoming more common to utilize third parties, otherwise referred to as sub-contractors, to complete sub-projects. These sub-contractors are external to the company and the processing environment in which the project is controlled, such as being external to databases where the project data is stored upon collection.

In adding third party entities to the data collection schema of a project, additional concerns and issues arise. One issue is the coordination of the various sub-projects for the different tasks. This coordination includes complexities not only as to the data, but also the timing of the data delivery and timing of data receipt.

Typically, a third party is given limited access to existing data, given access to only data required for completing the assigned sub-project. It is also important that the access be timely because different sub-projects are to be completed in a proper sequence. This data coordination further includes updating information in a periodic fashion because the sub-project may be completed over an extended period of time where periodic intermediate updates are requested.

One example of a complex project is a pharmaceutical drug approval program. This program is governed by strict governmental regulatory guidelines, including guidelines defined by the Food and Drug Administration (FDA). One aspect of a drug approval program is a clinical trial program. Components of these clinical trials can be performed by sub-contractors and the data reported back to the project manager in the pharmaceutical company. These trials may also include a number phases, where each phase includes numerous tasks and each task includes sub-projects.

In existing systems utilizing sub-contractors, these system still utilize the existing data collection technique with a resident database application. The existing system requires that all data be entered locally in the database. Therefore, this system requires a significant amount of duplication of data entry. All data collected by the third-party, as usable by the project manager, is initially collected and cataloged by the third-party. Then, this data is periodically assembled and may be digested as reportable data.

The reportable data is then provided in raw format to the project manager. This data is not integrated into the project manager's system. As such, the existing systems require re-entry of the reportable data into the project manager's database. In the example of a clinical trial, the sub-project may be related to monitoring a particular component of a drug, for example monitoring the effect on blood pressure. During the execution of the sub-projection, which may include delivering the drug to trial participants, various vital statistics may be collected for the participants. This vital statistic data is first entered into the sub-contractor's system. When the data is used by the project manager, this vital statistic data must then be manually re-entered or otherwise physically transferred to the central database.

In addition to data collection, in complex projects it is also important to monitor the timeliness of the third parties. Using the example of a drug approval project, certain phases, tasks and sub-tasks are given specific timeliness. The project as a whole has a larger timeline and the internal phase timeline, task timeline and sub-task timeline must be monitored. Existing systems may include the corresponding timeline, but do not include the ability to coordinate with third parties. As these existing systems are limited to internal data monitoring, there does not include functionality for monitoring and controlling the timeliness, data distribution and reception of data found with utilizing sub-contractors to perform sub-projects.

### BRIEF DESCRIPTION OF THE DRAWINGS

FIG. 1 illustrates a block diagram of one embodiment of an apparatus for cross company project management;

FIG. 2 illustrates a graphical representation of a project structure subject to cross company project management;

FIG. 3 illustrates a graphical representation of an exemplary status data input form usable for cross company project management;

FIG. 4 illustrates a flow chart outlining the steps of one embodiment of a method for cross company project management; and

FIG. 5 illustrates a graphical representation of a processing environment providing for cross company project management.

### DETAILED DESCRIPTION

In complex projects, specific sub-projects may be completed by one or more third parties, also commonly referred to as sub-contractors. Just as important as the task accomplished by the third party is the receipt and acclimation of the third party's data with the overall project data. Since complex projects have many sub-projects being performed by different third parties at different times with different data collection and reporting requirements, the cross company project management provides a means for not only managing the data but providing an efficient manner for managing the third parties themselves, the project overall and assimilating the data in the company's data storage facilities.

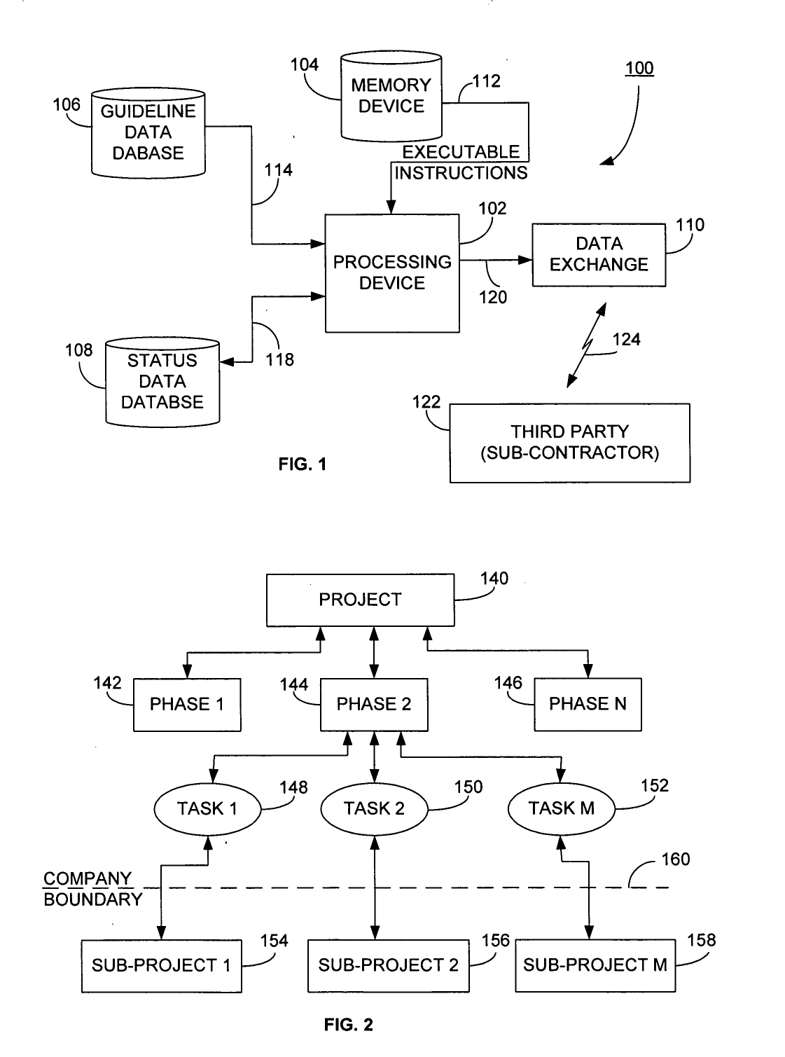

FIG. 1 illustrates a block diagram of one embodiment of an apparatus for cross company project management. The apparatus 100 includes a processing device 102 and a memory device 104. In the embodiment illustrated in FIG. 1, the apparatus 100 further includes, a guideline data database 106, a status data database 108 and a data exchange device 110. The processing device 102 may be one or more processing elements operative to perform various processing operations in response to executable instructions. The memory device 104 may be one or more memory elements having executable instructions 112 stored therein and the instructions 112 provideable to the processing device 102. In one embodiment, the memory device 104 may be a computer readable medium having the executable instructions 112 encoded thereon, such that when the memory device 104 is read by an appropriate medium reading device, the executable instructions 112 are read therefrom and provided to the processing device 102. The data exchange 110 may be a data interface operative to provide communication external to the apparatus 100.

The guideline data database 106 and the status data database 108 may be one or more data storage devices having data stored therein. These data storage devices 106 and 108 may be local or remote to the processing device 102, in operative communication across one or more available communication paths. The data in the data storage devices 106 and 108 may be provided for storage therein through the processor 102 using recognized data input techniques or in another embodiment, the databases 106 and/or 108 may be populated with data from other suitable external sources. For example, the guideline data 114 in the guideline data database 106 may be provided from a source defining a master project guideline.

In one embodiment, the processing device 102 receives the guideline data 114 from the guideline data database 106. This guideline data 114 may include a general outline of the steps of a particular project, including a definition of the various aspects of the project. FIG. 2 illustrates a graphical representation of a possible structure for a complex project 140. The project 140 may include a number of phases, such as phase 1 142, phase 2 144 and phase N 144, where N is an integer. Each phase may also include tasks, such as illustrated in FIG. 2 with phase 2 having M number of tasks, task 1 148, task 2 150 and task M 152, where M is an integer.

FIG. 2 graphically illustrates the general concept of elements of a project 140. For example, if the project 140 is a pharmaceutical project, phase 1 142 might be a research and development phase, phase 2 144 might be a clinical trial phase and phase N 146 might be an FDA approval phase, where the project 140 includes numerous other phases (not expressly illustrated) between phase 2 144 and phase N 146. In this example, the clinical trial phase 144 may have different tasks associated therewith, such as the dispensing of a drug to a first group and the dispensing of a placebo to a control group.

Illustrated in FIG. 2, there may be M number of tasks, as this may be dictated by individual factors associated with the type of drug, associated with reporting or clinical phase requirements for regulatory approval, corporate governance guidelines, or other factors relating to the project 140 itself. Each of these tasks (148, 150 and 152) may include sub-projects that can be performed by a third party or a sub-contractor. As illustrated in FIG. 2, each task 148, 150 and 152 includes a sub-project 154, 156 and 158 respectively. As these sub-projects 154, 156 and 158 may be more efficiently performed by the sub-contractor, the project 140 may include instructions for these sub-projects to be outsourced external to the company, as illustrated by the company boundary line 160 illustrating a defining line between operations that are done internal to the company and by an external third party.

Referring back to FIG. 1, the processing device 102 is operative to determine associated data utilized for each of the sub-projects. This associated data may be included within the guideline data 114 or in another embodiment not illustrated may be provided from another memory location. The associated data includes various levels of data used to complete the project, such as instructions for performing the sub-project (e.g. prescription guidelines for a drug trial) as well as documentation and other data that should be retained or generated for the overall project.

The processing device 102 is further operative to determine which of the sub-projects are to be completed by a third party. This may based on data included within the associated data, may be determined by user input indicating various sub-projects being assigned to particular sub-contractors or any other suitable technique as recognized by one skilled in the art. This determination provides an association of one or more sub-projects to specific third parties.

The guideline data 114 may also include timeline data which provides an indication of the timeliness of various phases, tasks and/or sub-projects. The project itself may have a defined timeframe and the timeline data provides the structure for completing the project. The processing device 102 may, based on the guideline data 114, determine when it is timely in the project and thereupon provide the associated data 120 to the third party 122 through the data exchange device 110. The data exchange device 110 may be implemented in hardware, software or a combination thereof and operative to modify or translate the data and provide the data to the third party 122 across a communication path 124, such as a secured wireless or networked connection.

The third party 122 may thereupon perform the corresponding functions of the sub-project. In the example of a drug trial, the third party 122 may dispense drugs and placebos to test subjects and periodically perform medical test (e.g. test blood pressure) of the patents. The third party 122 generates data that is used by the processing device 102 to continue processing the project.

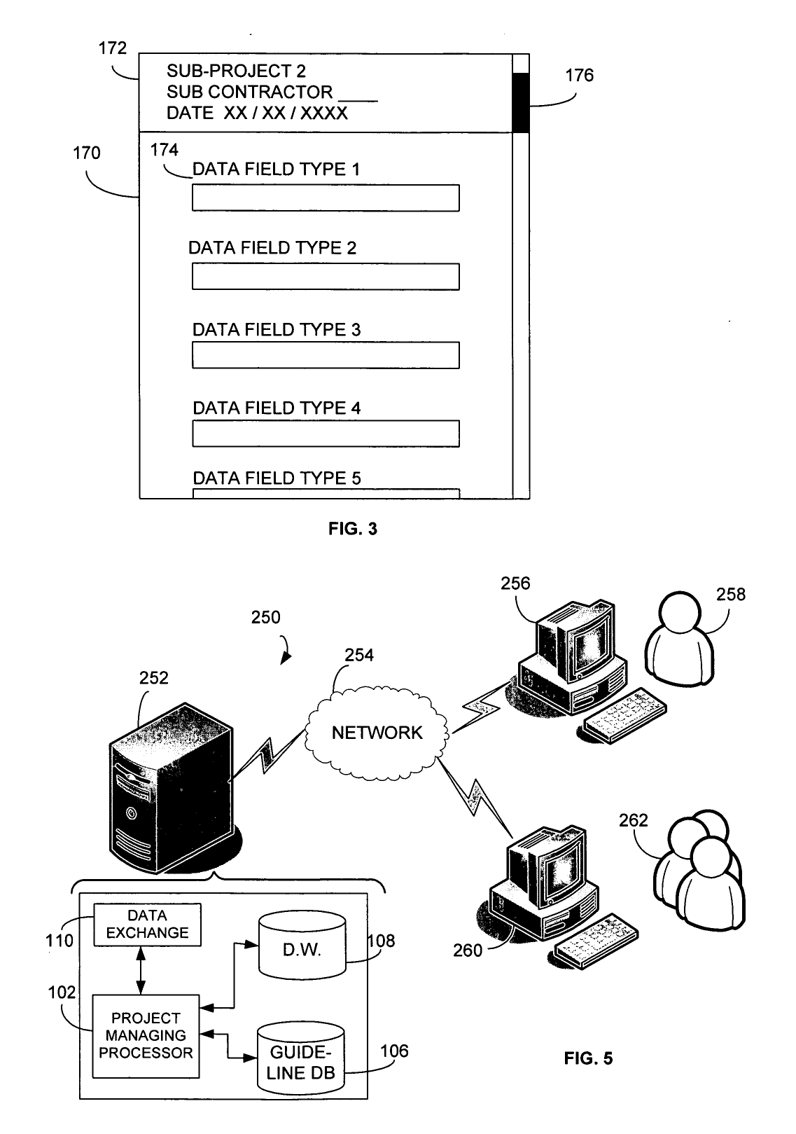

In the apparatus 100, the associated data 120 may include an electronic form usable by the third party. FIG. 3 illustrates a graphical representation of a sample form 170. The form 170 includes data fields, such as a header field 172 including information identifying the sub-project, the sub contractor and the corresponding date. The form 170 may also include any number of data fields 174 providing for the third party to enter project data relating to the underlying job commissioned for the third party. The form 170 of FIG. 3 is also illustrated with a scroll bar 176 on the side indicating that this electronic form is scrollable with further information fields, as more information may be requested. It is also recognized that the form 170 of FIG. 3 is for exemplary purposes only and that any suitable format may be utilized as recognized by one having ordinary skill in the art, the form 170 providing a means to provide the project data as acquired by the third party 122 to the data exchange 110 and eventually to the processing device 102.

The form 170 may be an electronic form encoded in one or more various encoding techniques. The form 170 provides a general form for allowing the input data to be provided back to the data exchange 110. For example, the form 170 may be encoded in a mark-up language encoding readable by a general browser or other application. In another embodiment, the form 170 may be encoded in a proprietary format usable by the third party 122. As the form 170 merely provides a technique for providing the input data to the data exchange, the form 170 is encoded to provide ease of use and translatability between the processing device 102 and any processing system that may be used by the third party 122.

Referring back to FIG. 1, the processing device 102 is operative to receive updated project data from the third party 122 through the data exchange 110. The processing device 102 processes this project data including extracting extraneous data that may be included based on the form 170 of FIG. 3. This project data may include periodic information such as for an iterative process. The updated project data 118 may be readily stored in the status data database 108, which may also be referred to as a data warehouse.

The status data database (data warehouse) 108 may provide a central storage location for all the project data as it is received. In accordance with known data warehousing operations, this may also allow the data to be accessible by other processing elements or systems having access to the data warehouse 108. Additionally, it may provide a central repository for all data, which may be in accordance with guideline requirements, as well as provide a general location available for backing up and other means for insuring the data integrity.

From this project data 118, the processing device is operative to generate project status feedback data. The instructions for generating this data may be including in the guideline data 114, such as instructions to provide periodic status checks regarding the operations of the third party. The project status feedback data may also be triggered by certain defined events, such as benchmarks in the project involving research, development, a timeline or other factors.

The processing device 102 may thereupon provide the project status feedback data to a project manager based on the updated project data and the guideline data. The form of the project status feedback data may be dictated by the guideline data. For example, if a time-based benchmark, e.g. 12 months, is reached, the project status feedback data may be compiled to indicate the current status of the input data acquired from the third party 122. Formatting of this data may be specific to the underlying project and the different reporting requirements may also greatly differ based on factors of the project itself. It is through the processing device 102 that a person or entity managing the project (140 of FIG. 2) can monitor different aspects of the different phases (142, 144 146 of FIG. 2), different tasks (148, 150 152 of FIG. 2) of different phases and even different sub-projects (154, 156, 158 of FIG. 2) being performed by third parties outside of the control and outside of the data processing environment of the company conducting the project 140.

In one embodiment, feedback may be provided based on a determined format, such as including a project status form. Forms may be used to provide a generalized format for various levels of different tasks within the complex project. In one example, forms may be stored in the data warehouse 108. The type of form to be used for providing status information may be governed by the guideline data 114 readable by the processing device 102. The processing device 102 may retrieve a project status form from the data warehouse 108 based on the guideline data 114. In another embodiment, the project status form selected may be based on the corresponding benchmark, for example reaching the 12 month benchmark in a particular phase of a clinical trial.

The processing device 102, after retrieving the updated projected data from the data warehouse 108 may generate the project status feedback data which includes the updated projected data needed to complete the status form. This may include compiling existing data, culling extraneous data or other suitable operations. In generating the project status feedback data, the large amount of data received from the third party 122 and stored in the data warehouse 108 is utilized to inform a project manager of the status of the project.

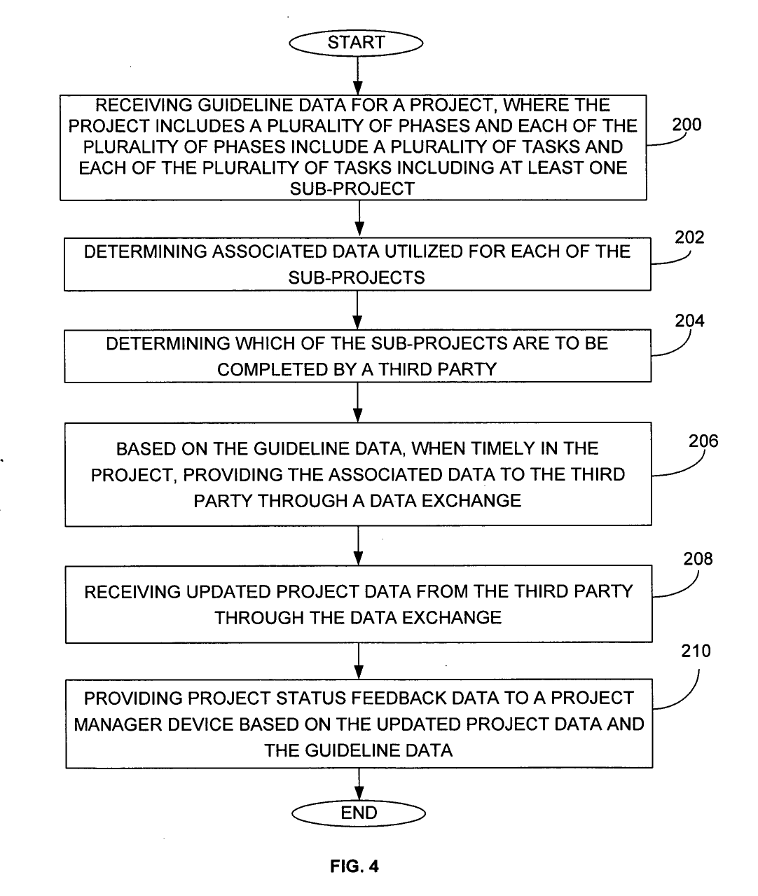

FIG. 4 illustrates a flowchart of the steps of one embodiment of a method for cross company project management. The first step of this embodiment, step 200, is receiving guideline data for a project where the project includes one or more phases and each of the phases include one or more tasks and each task includes one or more sub-projects. Whereas the above description referring to FIGS. 1-3 provide an exemplary embodiment of a project relating to a pharmaceutical research project, another exemplary embodiment may be a project relating to an engineering design, such as designing an automotive.

An engineering project may include numerous phases ranging from a conceptual phase to a design phase to a development phase to a testing phase and eventually to a production phase, for example. The received guideline data may outline the different phases of the engineering project, as well as the tasks and sub-projects for each phase. The guideline data may also include associated data such that the next step in one embodiment of this method is to determine associated data utilized for each of the sub-projects, step 202. This determination may include extracting particular data from the guideline data or in another embodiment may including accessing one or more data storage locations to retrieve the data that is usable for each of the sub-projects.

The next step, step 204, is determining which of the sub-projects are to be completed by a third-party. It is recognized that not all sub-projects are outsourced to third parties, therefore different techniques may be applicable to gather the proper data or monitor the completion of sub-projects performed internally or externally to the company performing the project. This step may include a corresponding list of which third party is assigned to which sub-project, if that information is available. In another embodiment, this step may include indicating where third parties are needed and an indication if a particular third party has been obtained for completing this sub-project. In the example of an automotive engineering project, steps relating to the design may be internally except for provisions relating to a specialized engine, such as a premium engine available in a high end model of the vehicle. The determination may include indicating that the sub-project relating to design of a super-charged engine needs to be outsourced, as well an indication that a third party needs to be contacted or a recommendation based on previous engagements with existing third parties.

The next step, step 206, is providing the associated data to the third party through a data exchange based on the guideline data, at the appropriate time in the timeframe of the project,. As many phases and tasks in the project are done in a sequential manner, this step may be performed based on tracking the status of the project. In the example of an engine design, associated data may not be provided to a third party engine designer until the specifics of the vehicle design are completed. In this embodiment, the associated data may include the proper specification information needed by the third party to design the engine. In one embodiment, the associated data may further include one or more status update forms readable by a third party processing system for the third party to provide status information back.

The next step, step 208, is receiving updated project data from the third party through the data exchange. In the example of an engine design, the updated project data may include the current status of the design project with associated information on the design, such as current levels of achievable fuel efficiency, torque levels, power requirements and other factors. In further embodiments, this updated project data may be stored in a data warehouse, which can provide a central storage repository for data.

The next step, step 210, includes providing project status feedback data back to a project manager based on the updated project data and the guideline data. This step may include retrieving updated project data from the data warehouse to generate the project status feedback data. This step may further include retrieving a project status form from the data warehouse, where the project status form can be one or more predetermined forms preferred by the project manager for various project updates. Additionally the project status form may be electronically completed using the project status feedback data such that the project status form itself is provided to the project manager. As such, in one embodiment, the method is complete.

FIG. 5 illustrates a graphical illustration of a processing environment 250 including a processing server 252 accessible across a network 254. The server 250 is accessible by a processing device 256 usable by a project manager 258. The communication with the server 252 across the network 254 may utilizes data communication techniques as recognized by one having ordinary skill in the art.

As illustrated in FIG. 5, the server 252 includes, among other processing elements, the data exchange 110, the project managing processor 102, the data warehouse 108, previously also referred to as the status data database, and the guideline data database 106. The elements in the server 252 may operate in accordance with the techniques described above.

The system of FIG. 5 further includes a third party computing device 260 usable by a third party 262. The third party computing device 260 is operative to receive communications with the server 252 across the network 254, also using known data transfer techniques. In a typical embodiment, the server 252 and the project manager 258 may be within the same company and the third party 262 is outside of the company, therefore the communications between the third party 262 and the server 252 may include additional security or verification features, among others.

Through the utilization of cross company project management, complex projects may be effectively managed by the distribution of tasks and sub-projects to third parties with effective monitoring and overall reporting functionalities. Using a processing device to monitor the activities allows a general oversight, where the activities of the processing device are governed in part by guidelines for the project. These operations allow for superior project management and the effective outsourcing of activities to third parties. This system also allows for monitoring tasks and/or phases having various aspects partially completed internally and partially completed externally by tracking the status of the outsourced sub-projects.

Although the preceding text sets forth a detailed description of various embodiments, it should be understood that the legal scope of the invention is defined by the words of the claims set forth below. The detailed description is to be construed as exemplary only and does not describe every possible embodiment of the invention since describing every possible embodiment would be impractical, if not impossible. Numerous alternative embodiments could be implemented, using either current technology or technology developed after the filing date of this patent, which would still fall within the scope of the claims defining the invention.

It should be understood that there exist implementations of other variations and modifications of the invention and its various aspects, as may be readily apparent to those of ordinary skill in the art, and that the invention is not limited by specific embodiments described herein. It is therefore contemplated to cover any and all modifications, variations or equivalents that fall within the scope of the basic underlying principals disclosed and claimed herein.

What is claimed is:

1. A method for cross company project management, the method comprising:
receiving guideline data for a project, where the project includes a plurality of phases and each of the plurality of phases include a plurality of tasks and each of the plurality of tasks including at least one sub-project;
determining associated data utilized for each of the sub-projects;
determining which of the sub-projects are to be completed by a third party;
based on the guideline data, when timely in the project, providing the associated data to the third party through a data exchange;
receiving updated project data from the third party through the data exchange; and
providing project status feedback data to a project manager device based on the updated project data and the guideline data.

2. The method of claim 1 the method further comprising:
providing the associated data to a third party processing device through the data exchange.

3. The method of claim 1 wherein the associated data includes instructions for each of the sub-projects such that the instructions are provided to the third party.

4. The method of claim 1 further comprising:
storing the updated project data received from the third party in a data warehouse; and
retrieving the updated project data from the data warehouse to generate the project status feedback data.

5. The method of claim 4 further comprising:
retrieving a project status form from the data warehouse;
electronically completing the project status form based on the project status feedback data; and
providing the project status form to a project manager.

6. The method of claim 1 wherein the associated data for each sub-project includes at least one electronic form usable by the third party for receiving the updated project data within the electronic form.

7. The method of claim 6 wherein the updated project data is received through the data exchange based on being entered into the electronic form and the electronic form is at least one of a mark-up language encoded form and a proprietary format language form.

8. An apparatus for cross company project management, the apparatus comprising:
a memory device having executable instructions stored therein;
a guideline data database having guideline data stored therein;
a data exchange device; and
a processing device, in response to the executable instructions, operative to:
receive the guideline data for a project, where the project includes a plurality of phases and each of the plurality of phases include a plurality of tasks and each of the plurality of tasks including at least one sub-project;
determine associated data utilized for each of the sub-projects;
determine which of the sub-projects are to be completed by a third party;
based on the guideline data, when timely in the project, provide the associated data to the third party through the data exchange device;
receive updated project data from the third party through the data exchange device; and
provide project status feedback data to a project manager device based on the updated project data and the guideline data.

9. The apparatus of claim 8, the processing device further operative to:
provide the associated data to a third party processing device through the data exchange.

10. The apparatus of claim 9 wherein the associated data includes instructions for each of the sub-projects such that the instructions are provided to the third party.

11. The apparatus of claim 8 further comprising:
a data warehouse; and
the processing device is further operative to:
store the updated project data received from the third party in a data warehouse; and
retrieve the updated project data from the data warehouse to generate the project status feedback data.

12. The apparatus of claim 11, the processing further operative to:
retrieve a project status form from the data warehouse;
electronically complete the project status form based on the project status feedback data; and
provide the project status form to a project manager.

13. The apparatus of claim 8 wherein the associated data for each sub-project includes at least one electronic form usable by the third party for receiving the updated project data within the electronic form.

14. The apparatus of claim 13 wherein the updated project data is received through the data exchange based on being entered into the electronic form and the electronic form is at least one of a mark-up language encoded form or a proprietary format language form.

15. A computer readable medium including executable instructions for cross company project management that when read by a processing device, the executable instructions provide for:
receiving guideline data for a project, where the project includes a plurality of phases and each of the plurality of phases include a plurality of tasks and each of the plurality of tasks including at least one sub-project;
determining associated data utilized for each of the sub-projects;
determining which of the sub-projects are to be completed by a third party;
based on the guideline data, when timely in the project, providing the associated data to the third party through a data exchange;
receiving updated project data from the third party through the data exchange; and
providing project status feedback data to a project manager device based on the updated project data and the guideline data.

16. The computer readable medium of claim 15 including further executable instructions that when read by the processing device provide for:
providing the associated data to a third party processing device through the data exchange.

17. The computer readable medium of claim 15 wherein the associated data includes instructions for each of the sub-projects such that the instructions are provided to the third party.

18. The computer readable medium of claim 15 includes further executable instructions that when read by the processing device provide for:
storing the updated project data received from the third party in a data warehouse; and
retrieving the updated project data from the data warehouse to generate the project status feedback data.

19. The computer readable medium of claim 18 including further executable instructions that when read by the processing device provide for:
retrieving a project status form from the data warehouse;
electronically completing the project status form based on the project status feedback data; and
providing the project status form to a project manager.

20. The computer readable medium of claim 19 wherein the associated data for each sub-project includes at least one electronic form usable by the third party for receiving the updated project data within the electronic form.

21. The computer readable medium of claim 20 wherein the updated project data is received through the data exchange based on being entered into the electronic form and the data exchange includes a web server and the electronic form is at least one of a mark-up language encoded form or a proprietary format language form.
